(19) United States
(12) Patent Application Publication
(10) Pub. No.: US 2026/0167439 A1
(43) Pub. Date: Jun. 18, 2026

(54) TUBE INSERT TO PREVENT CHATTERING

(71) Applicant: Innovation Associates Inc., Johnson City, NY (US)

(72) Inventor: Benjamin Barnum, Johnson City, NY (US)

(21) Appl. No.: 19/420,044

(22) Filed: Dec. 15, 2025

Related U.S. Application Data
(60) Provisional application No. 63/733,735, filed on Dec. 13, 2024.

(51) Int. Cl. B65G 53/52; B65G 51/02

(52) U.S. Cl. CPC B65G 53/526; B65G 51/02

(57) ABSTRACT

An apparatus, system, and method for reducing or eliminating the instance of spolling for a medication vial in a pneumatic conveyance system is provided. A spolling-reduction tube has at least one lobe defined by at least two ridges and configured to nest a vial of a relatively small diameter between the ridges. The ridges are configured to prevent the medication vial from rolling within the inside diameter of the pneumatic conveyance system tubing. A tapered region of the spolling-reduction tube is configured to guide the medication vial toward the internal diameter of a pneumatic conveyance system tubing.

### RELATED APPLICATIONS

This application claims the benefit of and priority to U.S. Provisional Patent Application No. 63/733,735 filed Dec. 13, 2024, entitled “TUBE INSERT TO PREVENT CHATTERING”, the entirety of which is incorporated herein by reference.

### BACKGROUND

Pneumatic conveyance systems are convenient and efficient systems for the transportation of cylindrical apparatus, such as medication vials. These conveyance systems use forced air through cylindrical tubing to deliver medication vials from one point to another. However, these medication vials vary in size and shape depending on the type of drug, manufacturer, etc. If the difference in diameter between the pneumatic conveyance system tubing diameter and the medication vial diameter is too large, the medication vial can start to spoll—a condition where the medication vials spin around their central axis while the top and bottom edges roll along the inside of the tube in opposite directions. “Spoll” or “spolling” as used herein may also be referred to colloquially as “chattering”.

Spolling can cause the medication vial to travel through the pneumatic conveyance system at a significantly decreased speed, causing interruptions on the line and inefficiencies in drug preparation processes. No known solution to spolling exists besides ensuring that the difference in diameters between the tubing and the vials is minimal, but this is not always achievable if different sized vials are to be used in the same tubing.

A need accordingly exists for an apparatus that reduces or eliminates the instance of spolling in pneumatic conveyance systems without changing the diameter of the pneumatic conveyance system tubing, so that multiple sizes of vials can be sent through the same pneumatic conveyance system. The apparatus should accommodate vials of every size up to the diameter of the pneumatic conveyance system tubing so that no inadvertent problems are created with vial sizes that did not experience spolling in the past either.

### SUMMARY

Example systems, methods, and apparatus are disclosed herein for reducing the instance of spolling in a pneumatic conveyance system. Specifically, systems, methods, and apparatus for spoll-reduction in a blower-fed pneumatic conveyance system are disclosed.

In light of the disclosure herein and without limiting the disclosure in any way, in an aspect of the present disclosure, which may be combined with any other aspect listed herein unless specified otherwise, a spoll-reduction tube segment comprises an entrance end, an exit end, a minor diameter, at least one lobe extending radially from the minor diameter and defining a diameter larger than the minor diameter in at least a portion of the lobe, and at least one tapered region, wherein the at least one lobe terminates in at least two ridges substantially tangential to a cylindrical space defined by the minor diameter.

In another aspect of the present disclosure, which may be combined with any other aspect in combination with any other aspect listed herein unless specified otherwise, the entrance end and the exit end are configured to adapt the tube segment into a pneumatic conveyance system.

In another aspect of the present disclosure, which may be combined with any other aspect in combination with any other aspect listed herein unless specified otherwise, the pneumatic conveyance system is a medicament container pneumatic conveyance system.

In another aspect of the present disclosure, which may be combined with any other aspect in combination with any other aspect listed herein unless specified otherwise, the tube segment comprises three lobes.

In another aspect of the present disclosure, which may be combined with any other aspect in combination with any other aspect listed herein unless specified otherwise, the three lobes have identical diameters.

In another aspect of the present disclosure, which may be combined with any other aspect in combination with any other aspect listed herein unless specified otherwise, the three lobes are arranged equidistantly radially about the minor diameter.

In another aspect of the present disclosure, which may be combined with any other aspect in combination with any other aspect listed herein unless specified otherwise, at least two of the lobes have different diameters.

In another aspect of the present disclosure, which may be combined with any other aspect in combination with any other aspect listed herein unless specified otherwise, the lobes are arranged non-equidistantly radially about the minor diameter.

In another aspect of the present disclosure, which may be combined with any other aspect in combination with any other aspect listed herein unless specified otherwise, at least one lobe is configured to accept a medicament container having a first outer diameter and the at least one lobe having a different diameter is configured to accept a medicament container having a second outer diameter, wherein the first outer diameter is different than the second outer diameter.

In another aspect of the present disclosure, which may be combined with any other aspect in combination with any other aspect listed herein unless specified otherwise, the at least one tapered portion is configured to guide a medicament container nested into the at least one lobe towards the minor diameter.

In another aspect of the present disclosure, which may be combined with any other aspect in combination with any other aspect listed herein unless specified otherwise, the spolling-reduction tube segment further comprises a cylindrical portion extending to the entrance end and a cylindrical portion extending to the exit end, wherein the cylindrical portion extending to the entrance end, the cylindrical portion extending to the exit end, and the minor diameter are concentric.

In another aspect of the present disclosure, which may be combined with any other aspect in combination with any other aspect listed herein unless specified otherwise, the spolling-reduction tube segment further comprises a cylindrical portion extending to the entrance end and a cylindrical portion extending to the exit end, wherein the cylindrical portion extending to the entrance end and the cylindrical portion extending to the exit end are non-concentric.

In another aspect of the present disclosure, which may be combined with any other aspect in combination with any other aspect listed herein unless specified otherwise, the spolling-reduction tube segment further comprises a polymer material.

In another aspect of the present disclosure, which may be combined with any other aspect in combination with any other aspect listed herein unless specified otherwise, a method of reducing spolling of bottles in a pneumatic conveyance system comprises providing a spolling-reduction tube segment in line of the pneumatic conveyance system and causing at least one bottle to enter and pass through the spolling-reduction tube segment, wherein the spolling-reduction tube segment comprises an entrance end, an exit end, a minor diameter, at least one lobe extending radially from the minor diameter and defining a diameter larger than the minor diameter in at least a portion of the lobe, and at least one tapered region, wherein the at least one lobe terminates in at least two ridges substantially tangential to a cylindrical space defined by the minor diameter.

In another aspect of the present disclosure, which may be combined with any other aspect in combination with any other aspect listed herein unless specified otherwise, the spolling-reduction tube segment is configured to at least partially nest a spolling bottle in the at least one lobe to at least partially stop the spolling motion.

In another aspect of the present disclosure, which may be combined with any other aspect in combination with any other aspect listed herein unless specified otherwise, the spolling-reduction tube segment is configured to guide the bottle toward the minor diameter and the exit end by the at least one tapered region.

In another aspect of the present disclosure, which may be combined with any other aspect in combination with any other aspect listed herein unless specified otherwise, the at least one bottle is a medicament container.

In another aspect of the present disclosure, which may be combined with any other aspect in combination with any other aspect listed herein unless specified otherwise, the pneumatic conveyance system is a medicament container pneumatic conveyance system.

In another aspect of the present disclosure, which may be combined with any other aspect in combination with any other aspect listed herein unless specified otherwise, the spolling-reduction tube segment is configured to be retrofit into an existing medicament container pneumatic conveyance system.

In another aspect of the present disclosure, which may be combined with any other aspect in combination with any other aspect listed herein unless specified otherwise, the spolling-reduction tube segment is passive.

In light of the present disclosure and the above aspects, it is therefore an advantage of the present disclosure to provide a tubing insert configured to reduce the instance of spolling in a pneumatic conveyance system without wasting the vial.

It is another advantage of the present disclosure to provide a passive apparatus to ensure proper fluid flow around a vial in a pneumatic conveyance system.

It is another advantage of the present disclosure to provide a modular system that may be retrofit into existing pneumatic conveyance systems without undue difficulty or cost.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 shows an isometric front view of a spolling-reduction tube system, according to an example embodiment of the present disclosure.

FIG. 2A shows a right wireframe view of a spolling-reduction tube system, according to an example embodiment.

FIG. 2B shows a cross-sectional view of the spolling-reduction tube system of FIG. 2A.

FIG. 3A shows a front wireframe view of a spolling-reduction tube system, according to an example embodiment.

FIG. 3B shows a cross-sectional view of the spolling-reduction tube system of FIG. 3A.

FIG. 4A shows a right side view of a spolling-reduction tube system in line of a pneumatic conveyance system, according to an example embodiment.

FIG. 4B shows a cross-sectional view of the spolling-reduction tube system of FIG. 4A with a relatively small diameter medicament bottle disposed within the spolling-reduction tube system.

FIG. 4C shows a cross-sectional view of the spolling-reduction tube system of FIG. 4A with a relatively large diameter medicament bottle disposed within the spolling-reduction tube system.

FIG. 5 is a flowchart of a spolling-reduction tube process, according to an example embodiment of the present disclosure.

### DETAILED DESCRIPTION

Methods, systems, and apparatus are disclosed herein for reducing instances of spolling for vials in a pneumatic conveyance system. Specifically, systems, methods, and apparatus for proper conveyance of medication vials in a blower-fed pneumatic conveyance system are disclosed. The reduction or elimination of spolling vials enables an elimination of wasting vials and inefficiencies in the pneumatic conveyance systems during travel to a destination. The methods, systems, and apparatus are configured to be passive and able to be retrofit to an existing pneumatic conveyance system. Lobes of differing radii are employed to handle the spolling of vials of different diameters in the same pneumatic conveyance system.

Reference is made herein to medication vials. A medication vial may refer to a medication bottle, vial carrier, or other container for housing and moving medication. The medication held within the medication container may include pills, tablets, or other solid, gel, or liquid pharmaceutical drug dosage that is consumed by a patient. A medication may also include a compounded pharmaceutical that is prepared from two or more substances. The term medication is not intended to be limiting, and may be used interchangeably with terms such as medicament or drug.

A medication vial usually includes a cylindrical portion and a threaded region around an opening to accept a lid to ensure the medication stored within is secured and not able to be contaminated by exposure to outside elements. The medication vial also typically includes a label with medication information and/or patient information in its final state before patient disbursement. The label also includes a unique identifier for tracking the medication vial, such as a bar code. In some embodiments, the medication container may include a separate identifier to enable tracking of the medication container itself within a pharmacy automation system and/or a medication bagger system.

While the example methods, apparatus, and systems are disclosed herein as operating with medication vials, it should be appreciated that the methods, apparatus, and systems may be operable with other articles that have a bottle-type shape. For example, the methods, apparatus, and systems may provide for the routing of packages in a facility, products to be packaged in a facility, and/or components to be assembled into a product along an assembly line, such as for carbonated beverages or confections sold in bottles. The methods, apparatus, and systems are likewise applicable to a wide variety of products including, but not limited to, manufactured goods, perishable goods, food products, medical products, and other commercial products. It will be appreciated that the methods, apparatus, and systems may be used in other contexts as known by a person having ordinary skill in the art.

Furthermore, although the use of methods, systems, and apparatus for use in pneumatic conveyance systems is described, those of ordinary skill in the art will recognize that the use of such methods, systems, and apparatus are not limited to pneumatic conveyance systems, but could be used in other types of fluidic systems, such as hydraulic conveyance. Furthermore, the methods, systems, and apparatus are capable of employment in gravity-fed systems, since air may exist in these systems, still causing instances of spolling. Still further, although vials and bottles are described below, the methods, systems, and apparatus may be used on any geometry with a propensity to spolling, and the below is meant to show an illustrative embodiment rather than a limiting geometrical use.

Further yet, although the term “spolling-reduction tube” is used herein, it will be appreciated by those of skill in the art that the term “tube” may refer to a tubing segment or insert.

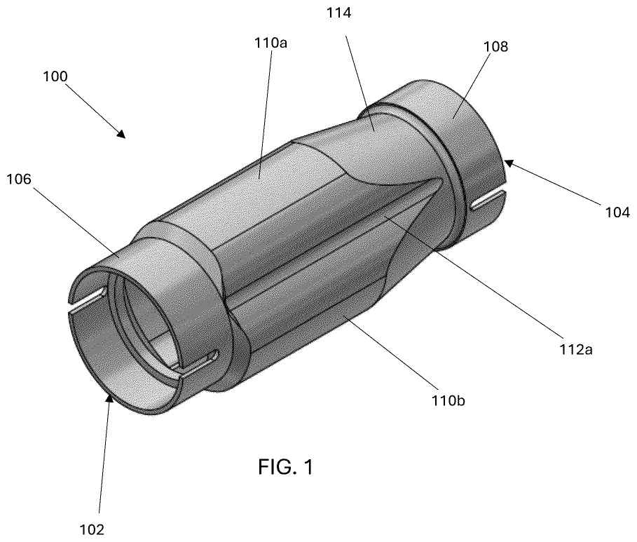

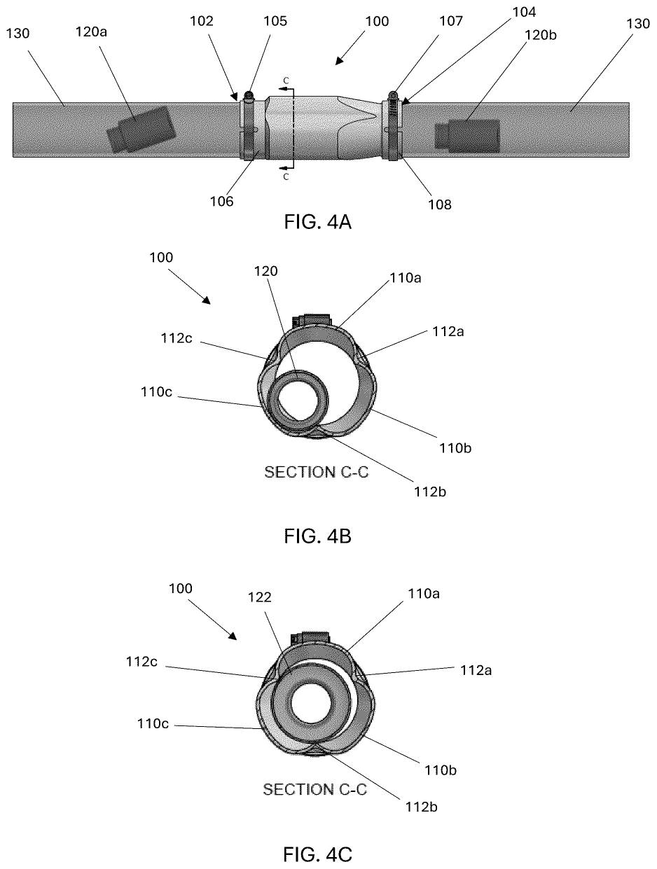

Turning now to FIG. 1, a spolling-reduction tube 100 comprises an entrance end 102, an exit end 104, at least one lobe 110a,b, and at least one tapered region 114. A first tubing adapter region 106 disposed toward the entrance end 102 and a second tubing adapter region 108 disposed toward the exit end 104 are configured to mate with the existing tubing on a pneumatic conveyance system (described in more detail in the description of FIG. 4A). The spolling-reduction tube 100 is configured to receive a medication vial from the entrance end 102 and deliver the medication vial through the exit end 104, with the medication vial passing through the spolling-reduction tube 100. The lobes 110a,b terminate in vertices or ridges 112a, the advantages of which will be described in further detail below.

The spolling-reduction tube 100 comprises the same material as the existing tubing on the pneumatic conveyance system in a preferred embodiment. In alternative embodiments, the spolling-reduction tube 100 comprises any suitable metal or plastic material such as polyurethane, nylon, polyethylene, polyvinyl chloride, polytetrafluoroethylene, steel, copper, aluminum, titanium, or any other suitable material. Preferably the spolling-reduction tube 100 is made of a material less hard than the medication vial so as not to damage the medication vial when passing through the spolling-reduction tube 100. The spolling-reduction tube 100 is preferably fabricated as a single integrated component by any suitable manufacturing method, such as injection molding, plastic casting methods, additive manufacturing, extrusion, or any other suitable method. Alternatively, the spolling-reduction tube 100 may be fabricated in two or more pieces to be permanently or releasably coupled before being provided to the pneumatic conveyance system.

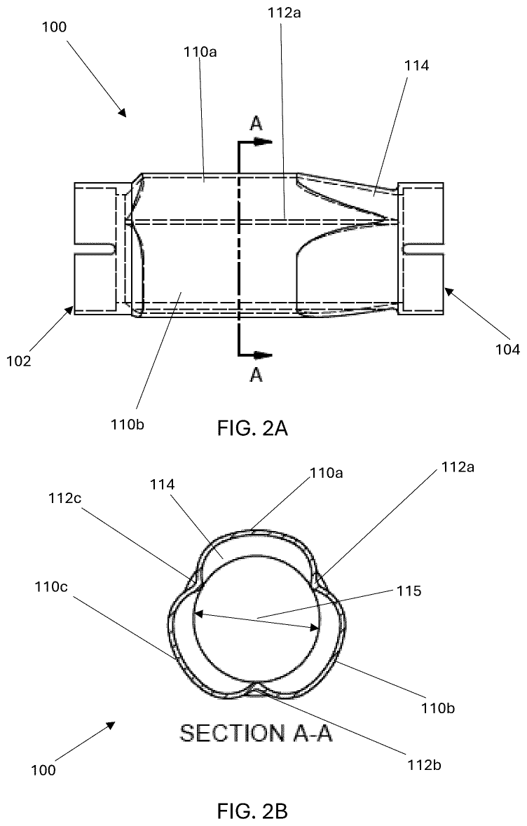

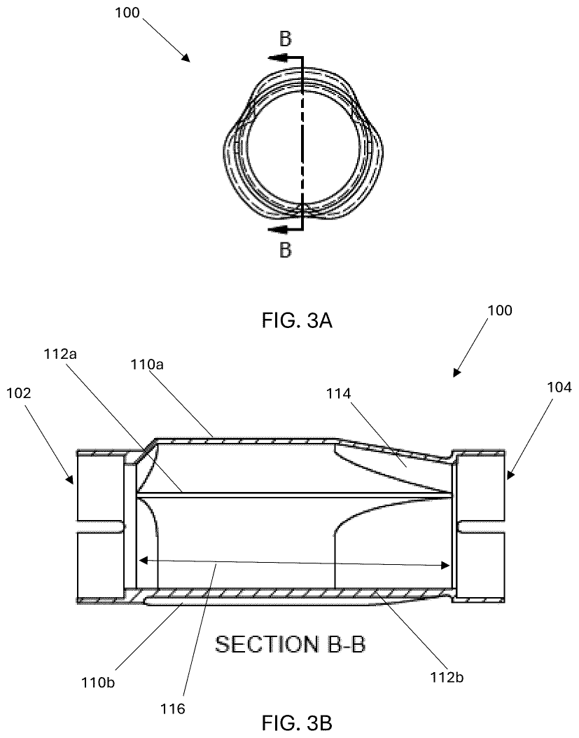

Turning now to FIGS. 2A-2B, the spolling-reduction tube 100 is shown in greater detail. The at least one lobe 110a-c comprises three lobes 110a-c in a preferred embodiment, meeting at three vertices or ridges 112a-c. The ridges 112a-c extend on the interior of the spolling-reduction tube 100 to about the level of the minor diameter 115 of the spolling-reduction tube 100. The minor diameter 115 in this context is the smallest fully circular feature in a cross section of the spolling-reduction tube (i.e. the cross section as seen from FIG. 3A). In some embodiments, the minor diameter 115 is about equal to the diameter of the tubing of the pneumatic conveyance system to which the spolling-reduction tube 100 is coupled. As medication vials enter the spolling-reduction tube 100 from the entrance end 102, those vials with smaller diameters are configured to be forced toward one of the lobes 110a-c between two of the ridges 112a-c. The ridges 112a-c ensure that the spolling bottle is prevented from rolling smoothly around the inside of the spolling-reduction tube 100. Those vials that are experiencing spolling rotate around their central axis and thereby contact one of the ridges 112a-c. Contact with the relatively sharp ridge 112a-c results in friction which counteracts the spolling momentum, reducing or eliminating the spolling of the vial. For this reason, the ridges 112a-c should be sharp enough to maintain hard contact with the medication vial, but should not be so sharp as to cause damage to the medication vial. For instance, the radius of the lobes 110a-c decreases toward the ridges 112a-c. However, the ridges 112a-c themselves have a chamfered, filleted, or rounded edge on the interior of the spolling-reduction tube 100. Although the ridges 112a-c extend inwardly all the way to the minor diameter 115 in the preferred embodiment, it is also contemplated that the ridges 112a-c do not extend all the way to the minor diameter 115 or extend past the minor diameter 115 (further into the interior of the spolling-reduction tube 100).

As the vials move through the spolling-reduction tube 100 past the lobes 110a-c, they meet the at least one tapered region 114, which gradually guides them from the area of greatest diameter in the interior of the spolling-reduction tube 100 back to the minor diameter 115, so that the vials re-enter the pneumatic conveyance system tubing at the level of the diameter of the pneumatic conveyance system tubing without undue shock or causing further irregularities in the vials'travels.

Although the embodiment shown has three lobes 110a-c, any number of lobes are contemplated. The appropriate number of lobes 110 may be determined by the diameter of the pneumatic conveyance system tubing (e.g. a tubing with a relatively very large diameter may call for a spolling-reduction tube 100 with six lobes 110, a tubing with a relatively very small diameter may call for a spolling-reduction tube 100 with only one lobe 110, etc.). The radii of each lobe 110a-c may also vary in any regard. For example, in a three-lobe 110a-c configuration, two lobes 110a-b may have a radius of one size, while the third lobe 110c has a radius of a different size, or all three lobes 110a-c may have a different radius from each other lobe 110a-c. Such a configuration may be helpful if there are many different sizes of vials that are sent through the spolling-reduction tube 100, so that each size of vial has a different radius of lobe 110a-c into which it may nest.

Although the embodiment shown has three ridges 112a-c, any number of ridges is contemplated, and corresponds to the number of lobes. For instance, in a one-lobe 110 configuration, the spolling-reduction tube 100 would still have two ridges 112a-b, with one at each side of the lobe 110.

Although the embodiment shown has the entrance end 102 and the exit end 104 in a concentric arrangement, in an alternative embodiment, the entrance end 102 and the exit end 104 are non-concentric. This may happen in a configuration where the spolling-reduction tube 100, for instance, has a curve to it, such as to be at a junction or bend of the pneumatic conveyance system. This may be found to be advantageous so that spolling vials are pushed to one side of the spolling-reduction tube 100, with the momentum of the vial pushing it into one of the lobes 110a-c.

Although the lobes 110a-c are shown in a straight arrangement from the entrance end 102 to the exit end 104, the lobes may be rifled in alternative embodiments so as to counteract a typical direction of spin from spolling vials or to impart a desired direction of spin.

Turning now to FIGS. 3A-3B, the internal structure of the spolling-reduction tube 100 can be seen more clearly from the side, with the lobes 110a-c leading to the at least one tapered region 114, while the ridges 112a-c extend from the beginning of the lobes 110a-c closest to the entrance end 102 all the way to the end of the at least one tapered region 114 closest to the exit end 104. The region of the lobes 110a-c and at least one tapered region 114 also comprises a length 116. In a preferred embodiment, this length 116 is about nine inches, so as to allow enough counteraction to be translated to a spolling vial in the spolling-reduction tube 100. In an alternative embodiment, any length up to an entirety of a length of pneumatic conveyance system tubing comprises the lobe 110a-c and ridge 112a-c structure of the spolling-reduction tube 100.

FIGS. 4A-C illustrate the action of a vial 120 through the spolling-reduction ube 100. As shown in FIG. 4A, a spolling vial 120a enters the spolling-reduction tube 100 from the entrance end 102 through the pneumatic conveyance system tubing 130. The spolling vial 120a is spolling such that the bottom of the spolling vial 120a and the top of the spolling vial 120a are contacting the pneumatic conveyance system tubing 130 on opposite sides of the internal diameter of the pneumatic conveyance system tubing 130 (or at least such that the distance between the two points of contact are non-linear). The spolling vial 120a rotates in two manners. In one manner, the spolling vial 120a rotates relative to the tube in one direction, for example the contact points between the top and bottom of the spolling vial 120a and the internal diameter of the pneumatic conveyance system tubing 130 may rotate in a clockwise direction when viewed from the entrance end 102 of the spolling-reduction tube 100, which may also be described as “rolling” along the internal diameter of the pneumatic conveyance system tubing 130. In a second manner, and simultaneously, the spolling vial 120a may be rotating counterclockwise in relation to itself when viewed from the entrance end 102 of the spolling-reduction tube 100, such that a singular point on the outer diameter of the bottom of the spolling vial 120a makes a full counterclockwise rotation around the perimeter of the outer diameter of the spolling vial 120a before returning to the same location on the spolling vial 120a. A non-spolling vial 120b then leaves the spolling-reduction tube 100 from the exit end 104 through the pneumatic conveyance system tubing 130.

As shown in FIG. 4B, a vial 120 with a smaller diameter (smaller than the distance between at least two of the ridges 112b-c, may become nested in the lobe 110c between those ridges 112b-c. The ridges 112b-c prevent the vial 120 from rolling and thus stop any instance of spolling. As shown in FIG. 4C, a vial 120 with a larger diameter (larger than the distance between at least two of the ridges 112a-c) may not nest fully into a lobe 110a-c. Because the difference in diameter between the larger diameter vial 120 and the pneumatic conveyance system tubing 130 is small, the vial 120 cannot as easily roll along the internal diameter of the pneumatic conveyance system tubing 130, and the instance of spolling is therefore already minimal, and nesting within one of the lobes 110a-c is unnecessary. The larger diameter vial 120 passes through the spolling-reduction tube 100 without significant effect on its motion.

As shown in FIG. 4A, the pneumatic conveyance system tubing 130 is coupled to the first tubing adapter region 106 and the second tubing adapter region 108. In a preferred embodiment, a first hose clamp 105 is used to secure the pneumatic conveyance system tubing 130 to the to the first tubing adapter region 106, and a second hose clamp 107 is used to secure the pneumatic conveyance system tubing 130 to the second tubing adapter region 108. In an alternative embodiment, the pneumatic conveyance system tubing 130 may be coupled to the first tubing adapter region 106 and the second tubing adapter region 108 by a slip fit or press fit, or may be resiliently affixed by, for example, an adhesive.

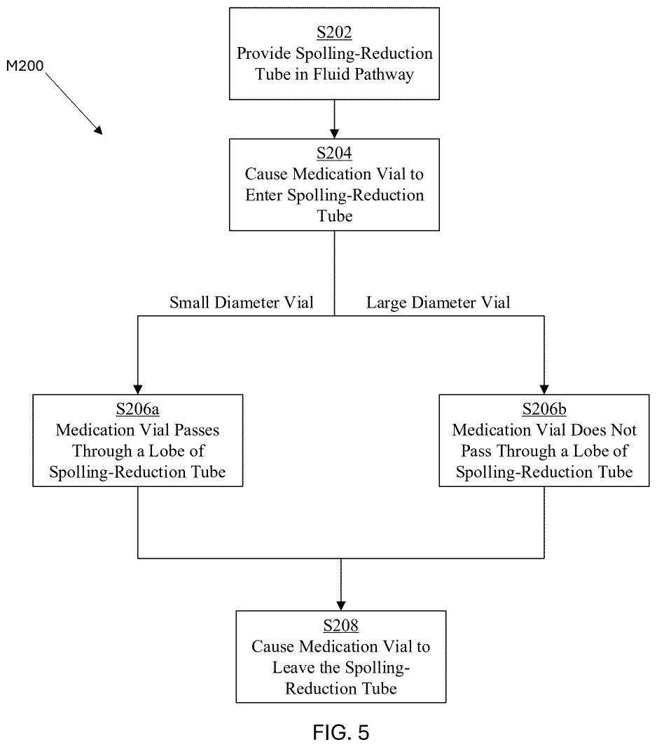

FIG. 5 describes a method M200 for use of the spolling-reduction tube 100. At a first step S202, a spolling-reduction tube according to the above description is provided in a fluid pathway such as a pneumatic conveyance system. At a next step S204, a medication vial is caused to enter the spolling-reduction tube. If the medication vial has a relatively small diameter, as described above, the process proceeds to step S206a, where the medication vial passes through at least one lobe of the spolling-reduction tube. If the medication vial has a relatively large diameter, as described above, the process proceeds to step S206b, where the medication vial passes through the spolling-reduction tube without passing through a lobe of the spolling-reduction tube. In either case, steps S206a and S206b proceed to step S208 upon their completions, where the medication vial is caused to leave the spolling-reduction tube and re-enter the fluid pathway (or reach the conclusion of its journey, in embodiments such as where the entirety of a length of pneumatic conveyance system tubing comprises the lobe and ridge structure of the spolling-reduction tube).

The methods described above may be performed in any order and the methods described above may include more, fewer, or other steps.

The use herein of the terms “about”, “approximately”, “substantially”, or equivalents thereon denotes a range of within at least ±10% or at least ±1 cm of the nominal value where appropriate, and includes the nominal value itself.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A tube segment for the reduction of spolling comprising:
an entrance end;
an exit end;
a minor diameter defined by a smallest fully circular feature in a cross section of the spolling-reduction tube;
at least one lobe extending radially from the minor diameter and defining a diameter larger than the minor diameter in at least a portion of the lobe; and
at least one tapered region,
wherein the at least one lobe terminates in at least two ridges substantially tangential to a cylindrical space within the spolling-reduction tube defined by the minor diameter.

2. The tube segment of claim 1, wherein the entrance end and the exit end are configured to adapt the tube segment into a pneumatic conveyance system.

3. The tube segment of claim 2, wherein the pneumatic conveyance system is a medicament container pneumatic conveyance system.

4. The tube segment of claim 1, wherein the tube segment comprises three lobes.

5. The tube segment of claim 4, wherein the three lobes have identical diameters.

6. The tube segment of claim 5, wherein the three lobes are arranged equidistantly radially about the minor diameter.

7. The tube segment of claim 4, wherein at least two of the lobes have different diameters.

8. The tube segment of claim 7, wherein the lobes are arranged non-equidistantly radially about the minor diameter.

9. The tube segment of claim 7, wherein at least one lobe is configured to accept a medicament container having a first outer diameter and wherein the at least one lobe having a different diameter is configured to accept a medicament container having a second outer diameter, wherein the first outer diameter is different than the second outer diameter.

10. The tube segment of claim 1, wherein the at least one tapered portion is configured to guide a medicament container nested into at least one of the at least one lobe towards the minor diameter.

11. The tube segment of claim 1, further comprising a cylindrical portion extending to the entrance end and a cylindrical portion extending to the exit end, wherein the cylindrical portion extending to the entrance end, the cylindrical portion extending to the exit end, and the minor diameter are concentric.

12. The tube segment of claim 1, further comprising a cylindrical portion extending to the entrance end and a cylindrical portion extending to the exit end, wherein the cylindrical portion extending to the entrance end and the cylindrical portion extending to the exit end are non-concentric.

13. The tube segment of claim 1, wherein the tube segment further comprises a polymer material.

14. A method of reducing spolling of bottles in a pneumatic conveyance system, the method comprising;
providing a spolling-reduction tube segment in line of the pneumatic conveyance system; and
causing at least one bottle to enter and pass through the spolling-reduction tube segment, wherein the spolling-reduction tube segment comprises:
an entrance end;
an exit end;
a minor diameter;
at least one lobe extending radially from the minor diameter and defining a diameter larger than the minor diameter in at least a portion of the lobe; and
at least one tapered region,
wherein the at least one lobe terminates in at least two ridges substantially tangential to a cylindrical space defined by the minor diameter.

15. The method of claim 14, wherein the spolling-reduction tube segment is configured to at least partially nest a spolling bottle in the at least one lobe to at least partially stop the spolling motion.

16. The method of claim 15, wherein the spolling-reduction tube segment is configured to guide the bottle toward the minor diameter and the exit end by the at least one tapered region.

17. The method of claim 14, wherein the at least one bottle is a medicament container.

18. The method of claim 17, wherein the pneumatic conveyance system is a medicament container pneumatic conveyance system.

19. The method of claim 18, wherein the spolling-reduction tube segment is configured to be retrofit into an existing medicament container pneumatic conveyance system.

20. The method of claim 14, wherein the spolling-reduction tube segment is passive.
